(19) United States
(12) Patent Application Publication
(10) Pub. No.: US 2011/0203752 A1
(43) Pub. Date: Aug. 25, 2011

(54) SCREEN DEVICE

(76) Inventor: Yasubumi Okachi, Yokohama-shi (JP)

(21) Appl. No.: 13/057,346

(22) PCT Filed: Jun. 5, 2009
(86) PCT No.: PCT/JP2009/060361

§ 371 Date: Apr. 11, 2011

(30) Foreign Application Priority Data
Aug. 6, 2008 (JP) 2008203551

(51) Int. Cl. E06B 9/24

(52) U.S. Cl. 160/372

(57) ABSTRACT

To provide a screen device wherein a first housing section 15 and a second housing section 16 configured to contain two slide guide frames 9 individually are disposed in the interior of the screen mounting frames 2, 3, the first housing section and the second housing section are arranged at different positions in the interior of the screen mounting frames, the two slide guide frames are connected to each other at respective free ends contained in the same screen mounting frames by tension members 21 each forming a loop 20 having no crossing point, whereby the less limitation to application of the size of the portion where the screen device is mounted such as an opening of a building is achieved.

### TECHNICAL FIELD

The present invention relates to a multi-purpose screen device which can be used as a curtain, a blind, a screen window, and a partition.

### BACKGROUND ART

As a device which is applicable to light-blocking and light-adjusting means such as a curtain or a blind, a screen window, or a partition and realizes smooth and stable opening and closing operation, the applicant of the present invention provides a screen device (for example, Patent Document 1).

The applicant of the present invention also provides a screen device described in Patent Document 2 as a device which ensures realization of a smooth parallel movement of a screen mounting frame of the screen device described in Patent Document 1.

In the screen device described in Patent Document 2, tension members each forming a figure eight loop are provided in the interiors of a pair of screen mounting frames arranged so as to oppose to each other at least one of which is slidable, a pair of slide guide frames disposed near both end portions of a screen mounted between the both screen mounting frames so as to allow free contraction and expansion on the sides different from the end portions mounted to the screen mounting frames are connected to each other by the tension members at least at a free end as one end, and a return point of the tension member is arranged on the opposite side from the side where the screen is mounted with the intermediary of the slide guide frame.

The slide guide frame includes rigid units, each having a pair of sidewalls arranged so as to oppose to each other and a bridging portion connecting the pair of sidewalls with respect to each other, continuously connected so as to be rotatable between the adjacent two rigid units. The slide guide frame is flexuous, and at least one end thereof is a free end so as to be capable of being contained in and drawn out from the screen mounting frame.

In the screen device described in Patent Document 2, since the pair of slide guide frames are connected to each other at the free ends thereof by the tension members each forming the figure eight loop, the amounts of movement of the both slide guide frames are almost the same. Therefore, the slide guide frames are contained in and drawn out from the screen mounting frames smoothly and, consequently, the screen mounting frames move smoothly in parallel, whereby the parallel movement is reliably realized.

### Patent Document 1: Japanese Patent No.3403652

### Patent Document 2: Japanese Patent No.3323461

### DISCLOSURE OF INVENTION

### Problems to be Solved by the Invention

As described above, the screen device described in Patent Document 2 has such superior performance that the screen mounting frames move smoothly and reliably in parallel. However, a point to be improved is found from a subsequent inspection.

In the screen device described in Patent Document 2, both the pair of slide guide frames are configured to be contained in the same hollow housing sections formed in the interiors of the screen mounting frames. Therefore, on the basis of the relation between the length of the slide guide frame determined univocally by a product width W of the screen device and the length of the screen mounting fame determined univocally by a product height H of the same, the screen device has such a design limitation that the relation of W:H is determined substantially to 1:1. In other words, the housing margin of the slide guide frame in the interior of the screen mounting frame is a width corresponding to half the width W.

From this reason, the screen device described in Patent Document 2 has a problem of being difficult to apply the invention to an opening of a building or the like having the larger width W with respect to the height H.

In view of such circumstances as described above, it is an object of the present invention to provide a screen device in which the less limitation to the size of a portion of installation such as an opening of a building is achieved.

### Means for Solving the Problems

In order to solve the above-described problems, the present invention has following characteristics.

The first aspect of the invention is a screen device including a screen which allows free contraction and expansion and is mounted between a pair of slidable screen mounting frames arranged on the left and right sides so as to oppose to each other, slide guide frames disposed respectively near both upper and lower end portions of the screen, the slide guide frames having flexibility, having free ends at both ends thereof, and being capable of being contained in and drawn out from the screen mounting frames and, on the other hand, the slide guide frames keeping their straightness at drawn out portions thereof when being drawn out from the screen mounting frames in association with the sliding movements of the screen mounting frames, characterized in that a first housing section and a second housing section configured to contain the two slide guide frames individually are disposed in the interior of the each screen mounting frame, the first housing section and the second housing section are arranged at different positions in the interior of the screen mounting frame, the two slide guide frames are connected to each other at the respective free ends contained in the same screen mounting frames by tension members each forming a loop having no crossing point.

In the first aspect of the invention, the second aspect of the invention is characterized in that the two slide guide frames are formed by continuously connecting rigid units each having a pair of side wall portions arranged so as to oppose to each other and a bridging portion which connects the both side wall portions to each other so as to allow rotation between the adjacent two rigid units.

In the first aspect of the invention, the third aspect of the invention is characterized in that the slide guide frame disposed near a lower end portion of the screen is formed by continuously connecting the rigid units each having the pair of side wall portions arranged so as to oppose to each other and the bridging portion which connects the both side wall portions to each other so as to allow rotation between the adjacent two rigid units, and the slide guide frame disposed near an upper end portion of the screen is formed of a band-shaped spring member having elasticity as well as flexibility.

In the third aspect of the invention, the fourth aspect of the invention is characterized in that a connect piece formed with engaging grooves at both left and right side end portions thereof is disposed at the free end of the upper slide guide frame formed of the band-shaped spring member, guide strips projecting inward from opposed inner wall surface portions of the screen mounting frame extending in the direction of the height of the screen mounting frame are disposed as the first housing section, and the guide strips are inserted into the engaging grooves of the connect piece, and the upper slide guide frame is slidable in the vertical direction in the first housing section by the connect piece being guided by the guide strips.

### Advantages

According to the first aspect of the invention, the first housing section and the second housing section configured to contain the two slide guide frames individually are disposed in the interior of the screen mounting frame, and the first housing section and the second housing section are arranged at the different positions in the interior of the screen mounting frame. Therefore, the housing margins of the slide guide frames in the first housing section and the second housing section are elongated to substantially the same length as the screen mounting frame, and the limitation of the ratio between the product width W and the product height H can be enlarged up to W:H≈2:1. The opening of the building or the like having the larger width W with respect to the height H can be applied without significant structural change. The less limitation to the size of the portion where the screen device is mounted such as the opening of the building is achieved

Also, according to the first aspect of the invention, since the two slide guide frames are connected to each other by the tension members each forming a loop having no cross point at the respective free ends contained in the same screen mounting frame, the both slide guide frames are contained in and drawn out from the screen mounting frame smoothly, so that the screen mounting frames move smoothly in parallel.

According to the second and third aspects of the invention, the advantages of the first invention are achieved equally both when both of the two slide guide frames are formed by continuously connecting the rigid units, and when the lower slide guide frame is formed by continuously connecting the rigid units and the upper slide guide frame is formed of the band-shaped spring member.

According to the third aspect of the invention, the thickness of the upper slide guide frame formed of the band-shaped spring member can be reduced, and hence the face measure dimension of the screen mounting frame can be reduced. The screen device superior also in appearance is achieved.

According to the fourth aspect of the invention, in addition to the advantage in the third aspect of the invention, the connect piece formed with the engaging grooves at both the left and right side end portions thereof is disposed at the free end of the upper slide guide frame formed of the band-shaped spring member, the guide strips projecting inward from opposed inner wall surface portions of the screen mounting frame and extending in the direction of the height of the screen mounting frame are disposed as the first housing section, the guide strips are inserted into the engaging grooves of the connect piece, and the upper slide guide frame is slidable in the vertical direction in the first housing section by the connect piece being guided by the guide strips. Therefore, the containing in and drawing out from the upper slide guide frame with respect to the first housing section is smoothly achieved.

### BEST MODE FOR CARRYING OUT THE INVENTION

FIG. 1 is a substantially front view showing an embodiment of a screen device according to the present invention.

In a screen device 1, a pair of screen mounting frames 2, 3 are disposed. The screen mounting frame 2, being arranged on the left side and the screen mounting frame 3, being arranged on the right side, are arranged on the left and right so as to oppose to each other. The both screen mounting frames 2, 3 are hollow bar members extending in the vertical direction, and can be formed by extrusion or the like using a light-weight material such as aluminum.

The screen mounting frames 2, 3 are both capable of making a sliding movement and make the sliding movement leftward and rightward. The screen device 1 includes an upper rail 4 having a substantially angular-C shape in cross-section, and the upper rail 4 is mounted in the lateral direction along an upper side of an inner edge of an opening of a building, for example, of a door or a window. In the screen device 1, a lower rail 5 to be arranged downward of the upper rail 4 so as to oppose thereto is disposed, and the lower rail 5 is mounted in the lateral direction along a lower side of the inner edge of the opening of the building, for example. Upper end portions of the screen mounting frames 2, 3 are contained inside the upper rail 4 and lower end portions thereof are arranged on the lower rail 5. Therefore, the leftward and rightward sliding movements of the screen mounting frames 2, 3 are guided by the upper rail 4 and the lower rail 5, so that stability is enhanced.

In contrast, the screen mounting frame 3 is fixed so that the screen mounting frames 2, 3 are maintained in parallel. For example, it is fixed to the right side of the inner edge of the opening of the building. In the screen device 1, it is also possible to configure the screen mounting frame 3 to be a sliding side, and the screen mounting frame 2 to be a fixed side. In this case, the screen mounting frame 2 can be fixed, for example, to the left side of the inner edge of the opening of the building.

A screen 6 is mounted between the screen mounting frames 2, 3 configured as described above. The screen 6 is pleated and is contractible and expandable between the screen mounting frames 2, 3. The screen 6 may be formed of a net when the screen device 1 is used as a screen window or the like, and may also be formed of a sheet formed of cloths or resin according to the application of the screen device 1. Alternatively, the contractible and expandable configuration may be achieved by, for example, a honeycomb structure or the like in addition to the pleat formed by the pleating process.

The screen 6 is expanded over the opening of the building when the screen mounting frame 2 makes the sliding movement toward the left and functions as a light-shield, a light dimmer, prevention of entry of insects, and so on. In contrast, when the screen mounting frame 2 makes the sliding movement toward the right, the screen 6 is contracted, and is folded between the screen mounting frames 2, 3.

The screen 6 is provided with supporting plates on both left and right end portions thereof and is mounted to the screen mounting frames 2, 3 via the supporting plates. As shown in FIG. 2, ribs 7 projecting in the width direction are disposed inside the screen mounting frames 2, 3. The screen 6 is mounted to the screen mounting frame 2 by the supporting plate inserted on the left side of the rib 7 and engaged with the rib 7 in a cantilevered manner. The screen 6 is mounted to the screen mounting frame 3 by the supporting plate inserted on the right side of the rib 7 and engaged with the rib 7 in a cantilevered manner.

Folded and contracted portions of the screen 6 are contained in a screen housing section 8 provided on the right side on the side of the screen mounting frame 2 and, the screen housing section 8 is provided on the left side so as to contain the screen on the side of the screen mounting frame 3. The screen mounting frame 2 moves rightward until a right end surface comes into contact with a left end surface of the screen mounting frame 3, and the screen 6 which is folded and contracted at this time is contained inside the screen mounting frames 2, 3 and hence is not exposed.

The screen 6 may be disposed with a tension member which penetrates through the screen 6 in the direction of contraction and expansion for supporting the same according to the size or the like. As the tension member, a suitable wire material which generates a tensile force such as string or wire is employed, and the material may be selected as needed considering durability or the like. There may be provided one, or two or more of the tension members. In the case where the plurality of tension members are provided, they may be disposed at regular intervals in the vertical direction of the screen 6. The tension members may be extended so as to be tightened between the screen mounting frames 2, 3, and the way to be routed in the interiors of the screen mounting frames 2, 3 is not specifically limited. For example, an adequate way such as bending downward once and then bent upward at the lower end portions of the screen mounting frames 2, 3 so as to obtain a required tensile force may be employed. The tension members secure the self-sustaining property of the screen 6 and enhance the surface strength. The contraction and the expansion are guided by the tension members, and are smoothly achieved.

In the screen device 1, slide guide frames 9 are disposed near the both upper and lower end portions of the screen 6. The slide guide frames 9 are each formed of rigid units 10 continuously connected so as to allow rotation between the two adjacent rigid units 10. As the slide guide frame 9, the slide guide frames described in Patent Documents 1 and 2, and provided thus far may be employed. Although the illustration is partly omitted in order to simplify the description, the rigid unit 10 includes a pair of side wall portions 11 arranged so as to oppose to each other and a bridging portion 12 connecting the side wall portions 11 with respect to each other. The sidewall 11 is disposed with a projection 13 so as to project outward at one end portion in the longitudinal direction and is formed a through hole to allow engagement of the projection 13 therewith at the other end portion. The sidewall 11 is also disposed with a small projection at a position adjacent to the projection 13 so as to project outward in the direction opposite from the through hole, and is formed with a substantially crescent-shaped elongated hole at a position adjacent to the through hole on the side of the projection 13. Two such the rigid units 10 adjacent to each other are continuously connected so as to be rotatable by fitting the projection 13 into the through hole from inside the sidewall 11 to achieve engagement, and inserting the small projection into the elongated hole, thereby forming the sliding guide frames 9. The sliding guide frames 9 are flexuous, and are capable of maintaining its straightness by the small projection coming into contact with one end of the elongated hole in the longitudinal direction and thereby limiting the rotation of the rigid unit 10.

Both of the two slide guide frames 9 have free ends both at left and right ends, and are not fixed to the screen mounting frames 2, 3, and can be contained in and drawn out from the screen mounting frames 2, 3. When the screen mounting frame 2 is slid leftward, the slide guide frames 9 are drawn out from the screen mounting frames 2, 3, and the portions drawn out therefrom keep their straightness. In contrast, when the screen mounting frame 2 is slid rightward, the slide guide frames 9 are bent at the upper end portions and the lower end portions of the screen mounting frames 2, 3, respectively, and are contained in the interiors of the screen mounting frames 2, 3. Containing in and drawing out from the slide guide frames 9 with respect to the screen mounting frames 2, 3 as described above are performed synchronously with the contraction and the expansion of the screen 6. The slide guide frames 9 are not exposed from the opening of the building, and hence do not hinder, for example, the opening and closing operation of the window or passage of people, whereby favorable in appearance.

The each slide guide frame 9 is disposed with a connecting member 14 at a lengthwise center portion and has a substantially symmetrical structure with respect to the connecting member 14 for achieving smooth containing in and drawing out from the both screen mounting frames 2, 3. The connecting member 14 may have a structure corresponding to the rigid unit 10 at an end of the connection of the slide guide frame 9, for example, may have a structure having a pair of side wall portions arranged to oppose to each other and a bridging portion connecting the both side wall portions to each other. The sidewall is provided with projections projecting outward at both end portions in the longitudinal direction, and the projections each have substantially the same shape and size as the projection 13 of the rigid unit 10 and is engageable with the through hole of the rigid unit 10. The side wall portion is disposed with a substantially crescent-shaped projection at an end edge side adjacent to the projection described above, and the substantially crescent-shaped projection is engageable with a substantially crescent-shaped elongated hole of the rigid unit 10. Then, the above-described projection of the connecting member 14 is fitted into and engaged with the through hole of the rigid unit 10 positioned at the end of the connection from inside, and the substantially crescent-shaped projection is fitted into and engaged with the elongated hole from inside, so that the slide guide frame 9 is formed into one piece by being connected by the connecting member 14 and has a substantially symmetrical structure with respect to the connecting member 14.

Furthermore, the screen device 1 is provided with a first housing sections 15 configured to contain the upper slide guide frame 9 and a second housing sections 16 configured to contain the lower slide guide frame 9 in the interiors of the screen mounting frames 2, 3. The first housing sections 15 are arranged on the left side in the screen mounting frame 2 and on the right side in the screen mounting frame 3, the second housing sections 16 are arranged on the right side in the screen mounting frame 2 and on the left side in the screen mounting frame 3, and are arranged at different positions in the interiors of the screen mounting frames 2, 3. Ribs 17 are disposed between the first housing section 15 and the second housing section 16. The ribs 17 project from corresponding inner wall surface portions 18, 19 in the screen mounting frames 2, 3 inward at the same positions of the screen mounting frames 2, 3 in the width direction. The first housing sections 15 and the second housing sections 16 are partitioned by the ribs 17.

When the screen mounting frame 2 is slid leftward, the upper slide guide frame 9 is drawn out from inside the first housing sections 15, and the lower slide guide frame 9 is drawn out from inside the second housing sections 16. When the screen mounting frame 2 is slid rightward, the upper slide guide frame 9 is contained in the first housing sections 15 and the lower slide guide frame 9 is contained in the second housing sections 16, and the two upper and lower slide guide frames 9 are individually contained in the first housing sections 15 and the second housing sections 16.

Then, in the screen device 1, the upper and lower slide guide frames 9 are connected to each other at the free ends contained in the screen mounting frame 2 and the free ends contained in the screen mounting frame 3, that is, at the respective free ends contained in the same screen mounting frames by tension members 21 each forming a loop 20 having no crossing point. As the tension member 21, in the same manner as the tension member which can be disposed so as to penetrate through the screen 6 in the direction of contraction and expansion, suitable wire materials which generate a tensile force such as string or wire is employed, and the material may be selected as needed considering the durability or the like.

Tension adjusting members 22 each having a smooth curved surface at upper and lower portions substantially at the widthwise center of the screen mounting frames 2, 3 are disposed in the interiors of the screen mounting frames 2, 3. The tension members 21 are entrained about the tension adjusting members 22 to form a loop 20 and are applied with a predetermined tensile force. The tension members 21 are entrained about the smooth curved surfaces, so that the tension adjusting members 22 can adjust the magnitude of the tensile forces applied to the tension members 21, and smoothen the movements of the tension members 22. The tension adjusting members 22 having the configuration as described above can generally be disposed in association with cap members mounted at the upper and lower end portions of the screen mounting frames 2, 3, or with guide members 30 in the case of a screen device 23 shown in FIG. 3, described later.

In the screen device 1 as described above, the housing margins of the screen mounting frames 2, 3 in the first housing sections 15 and the second housing sections 16 are enlarged substantially to the lengths of the screen mounting frames 2, 3 by the first housing sections 15 and the second housing sections 16. Therefore, the limitation of the ratio between a product width W and a product height H can be enlarged to W:H≈2:1. Therefore, the screen device 1 can be applied to the opening of the building having a larger width W with respect to the height H without significant change in structure. The less limitation to the size of the portion where the screen device is mounted such as the opening of the building is achieved.

In addition, since the two slide guide frames 9 are connected to each other by the tension members 21 each forming the loop 20 having no crossing point at the respective free ends, the both slide guide frames 9 are contained in and drawn out from the screen mounting frames 2, 3 smoothly, so that the screen mounting frames 2, 3 move in parallel to each other smoothly in the same manner as the screen device described in Patent Document 2.

Since the screen device 1 has a substantially symmetrical structure with respect to the center portion in a state in which the screen 6 is expanded entirely over the opening of the building, there is no difference in usability between the right hand and the left hand, so that the same feeling of operation can be obtained whichever of the screen mounting frame 2 and the screen mounting frame 3 is used for operation.

FIG. 3 is a cross-sectional view of a principal portion showing an embodiment of the screen device according to the invention from the front side. FIG. 4 is a cross-sectional view of a principal portion showing the peripheries of the screen mounting frames 2, 3 of the screen device 23 shown in FIG. 3. In FIG. 3 and FIG. 4, the same reference numerals are assigned to portions corresponding to the screen device 1 shown in FIG. 1 and FIG. 2, and the description thereof is omitted. In FIG. 3, illustration of the upper rail 4 and the lower rail 5 shown in FIG. 1 is omitted.

The screen device 23 includes tension members 24 penetrating through the screen 6 mounted between the screen mounting frames 2, 3 so as to be contractible and expandable in the directions of contraction and expansion by being pleated. As the tension member 24, a suitable wire material which generates a tensile force such as string or wire is employed, and the material may be selected as needed considering durability or the like. There may be provided one, or two or more of the tension members 24. In the case where the plurality of tension members are provided, they may be disposed at regular intervals in the vertical direction of the screen 6. The tension member 24 is fixed at one end thereof to the free end on the left end side of the lower slide guide frame 9 and at the other end thereof to the free end on the right end side of the lower slide guide frame 9, and is extended between the screen mounting frames 2, 3 so as to be tightened therebetween. The tension members 24 are bent downward in the interiors of the screen mounting frames 2, 3, and bent upward at the lower end portions of the screen mounting frames 2, 3 so as to obtain a required tensile force. The routing of the tension members 24 in the interiors of the screen mounting frames 2, 3 as described above is not specifically limited.

In the screen device 23, the lower slide guide frame 9 is formed by continuously connecting the rigid units 10, and the upper slide guide frame 9 is formed of a band-shaped spring member 25 having elasticity as well as flexibility.

In the lower slide guide frame 9, in the same manner as the screen device 1 shown in FIG. 1 and FIG. 2, the rigid unit 10 includes the pair of side wall portions 11 arranged so as to oppose to each other, and the bridging portion 12 connecting the both side wall portions 11 with respect to each other. The sidewall 11 is disposed with the projection 13 so as to project outward at one end portion in the longitudinal direction and is formed a through hole 26 to allow engagement of the projection 13 therewith at the other end portion. The sidewall 11 is also disposed with a small projection 27 at a position adjacent to the projection 13 so as to project outward at a position opposite from the through hole 26, and is formed with a substantially crescent-shaped elongated hole 28 at a position adjacent to the through hole 26 on the side of the projection 13. Two such the rigid units 10 adjacent to each other are continuously connected so as to be rotatable by fitting the projection 13 into the through hole 26 from inside the sidewall 11 to achieve engagement, and inserting the small projection 27 into the elongated hole 28, thereby forming sliding guide frames 9.

The each lower slide guide frame 9 is disposed with the connecting member 14 at the lengthwise center portion and has a substantially symmetrical structure with respect to the connecting member 14. The slide guide frame 9 is formed into one piece by being connected by the connecting member 14, and has a substantially symmetrical structure with respect to the connecting member 14. The guide members 30 each having a sliding contact surface 29 curved smoothly in the vertical direction are disposed at lower end portions of the second housing sections 16 of the screen mounting frames 2, 3, so that containing in and drawing out from the lower slide guide frame 9 formed by continuously connecting the rigid units 10 with respect to the second housing sections 16 is smoothly achieved. The guide members 30 configured in this manner can be disposed in the screen device 1 shown in FIG. 1 and, in the screen device 1, can be disposed at upper end portions of the first housing sections 15 and the lower end portions of the second housing sections 16.

The upper slide guide frame 9 is formed of the band-shaped spring member 25 having elasticity as well as flexibility as described above. The band-shaped spring member 25 is formed of a material often used for measuring tape referred to as “Convex” as a common name, and may be formed of metal, for example. The band-shaped spring member 25 has elasticity as well as flexibility in the thickness direction, generates elasticity in association with bending, restores to its initial state by being released, and can maintain its straightness. The screen device provided with the slide guide frame formed of the band-shaped spring member 25 in this configuration is described and proposed in JP-A-3312848 and so on by the applicant of the present invention.

The both left and right ends of the upper slide guide frame 9 formed of the band-shaped spring member 25 are also the free ends as in the case of the lower slide guide frame 9, are not fixed to the screen mounting frames 2, 3, and are capable of being contained in and drawn out from the first housing sections 15 of the screen mounting frames 2, 3. When the screen mounting frame 2 is slid leftward, the sliding guide frame 9 is drawn out from the first housing sections 15 of the screen mounting frames 2, 3, and the portions drawn out therefrom keep their straightness. In contrast, when the screen mounting frame 2 is slid rightward, the sliding guide frame 9 is bent at the upper end portions and the lower end portions of the screen mounting frames 2, 3 respectively, and are contained in the interior of the first housing sections 15 of the screen mounting frames 2, 3. The upper slide guide frame 9 formed of the band-shaped spring member 25 is not exposed from the opening of the building or the like, and hence does not hinder, for example, the opening and closing operation or the passage of people, whereby favorable in appearance.

In addition, the screen device 23 includes guide strips 31 projecting inward from the opposing inner wall surface portions 18, 19 of the screen mounting frames 2, 3 and extending in the direction of the height of the screen mounting frames 2, 3 as the first housing sections 15 configured to contain the upper slide guide frame 9 formed of the band-shaped spring member 25. The guide strips 31 are positioned adjacent to the boundaries with respect to the second housing sections 16 for containing the lower slide guide frame 9, but are arranged at substantially different positions from the second housing sections 16 in the interior of the screen mounting frames 2, 3 in terms of containing of the slide guide frames 9.

The upper slide guide frame 9 formed of the band-shaped spring member 25 is disposed at the free ends thereof with thin-plate connect pieces 32 by being fixed with screws 33 as shown in FIG. 5. The connect pieces 32 are each formed with engaging grooves 34 at both left and right end portions. As shown in FIG. 4, the guide strips 31 are inserted into the engaging grooves 34 of the connect piece 32, and the connect piece 32 is guided by the guide strips 31, so that the upper slide guide frame 9 can be slid in the vertical direction in the first housing sections 15. The upper slide guide frame 9 is connected to the lower slide guide frame 9 formed by continuously connecting the rigid units 10 with the tension members 21 forming a loop 20 having no crossing points as shown in FIG. 1 in the connect pieces 32 positioned at the free ends.

In the screen device 23 in this configuration as well, in the same manner as the screen device 1 shown in FIG. 1, the housing margins of the screen mounting frames 2, 3 in the first housing sections 15 and the second housing sections 16 are elongated to substantially the same length as that of the screen mounting frames 2, 3 by the first housing sections 15 and the second housing sections 16. Therefore, the limitation of the ratio between the product width W and the product height H can be enlarged to W:H≈2:1. Therefore, the screen device 1 can be applied to the opening of the building having the larger width W with respect to the height H without significant structural change. The less limitation to the size of the portion where the screen device is mounted such as the opening of the building is achieved.

In addition, since the two slide guide frames 9 are connected to each other by the tension members 21 each forming the loop 20 having no crossing point at the respective free ends, the both slide guide frames 9 are contained in and drawn out from the screen mounting frames 2, 3 smoothly, so that the screen mounting frames 2, 3 move smoothly in parallel.

Also, the connect pieces 32 are disposed at the free ends of the upper slide guide frame 9 formed of the band-shaped spring member 25, and the guide strips 31 extending in the vertical direction disposed as the first housing sections 15 of the screen mounting frames 2, 3 are inserted into the engaging grooves 34 formed at the both left and right end portions of the connect pieces 32, the connect pieces 32 are guided by the guide strips 31, so that the upper slide guide frame 9 formed of the band-shaped spring member 25 is slidable in the vertical direction in the first housing sections 15, whereby smooth containing in and drawing out from the upper slide guide frame 9 with respect to the first housing sections 15 is achieved.

Then, the thickness of the upper slide guide frame 9 formed of the band-shaped spring member 25 can be reduced to a thickness significantly smaller than the thickness of the lower slide guide frame 9 formed by continuously connecting the rigid units 10, so that the face measure dimensions of the screen mounting frames 2, 3, that is, the widths of the screen mounting frames 2, 3 can be reduced. Therefore, the screen device 23 is superior in appearance.

The screen device 23 has a substantially symmetrical structure with respect to the center portion in the state in which the screen 6 is expanded over the entire portion of the opening of the building or the like in the same manner as the screen device 1 shown in FIG. 1. Therefore, there is no difference in usability between the right hand and the left hand, so that the same feeling of operation can be obtained whichever of the screen mounting frame 2 and the screen mounting frame 3 is used for operation.

### BRIEF DESCRIPTION OF DRAWINGS

FIG. 1 is a schematic front view showing an embodiment of a screen device of the present invention.

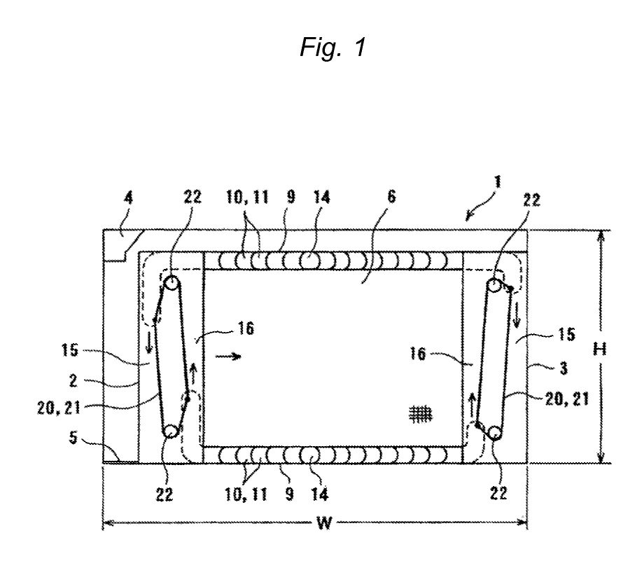

FIG. 2 is a cross-sectional view of a principal portion of a periphery of a screen mounting frame of the screen device shown in FIG. 1.

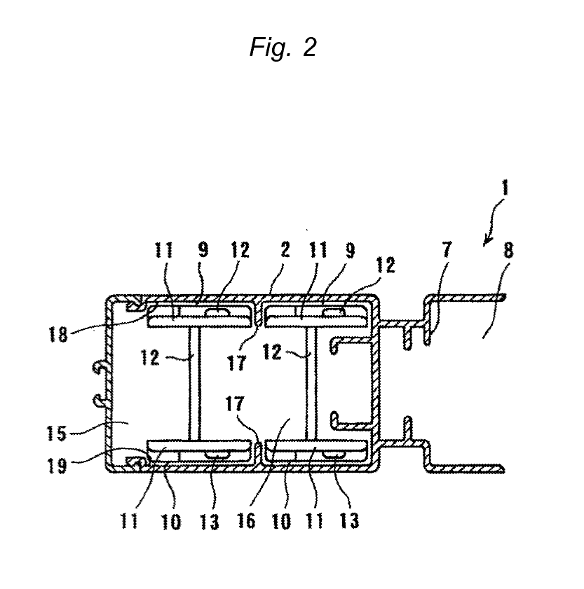

FIG. 3 is a cross-sectional view of the principal portion of the screen device according to the embodiment of the present invention shown from the front side.

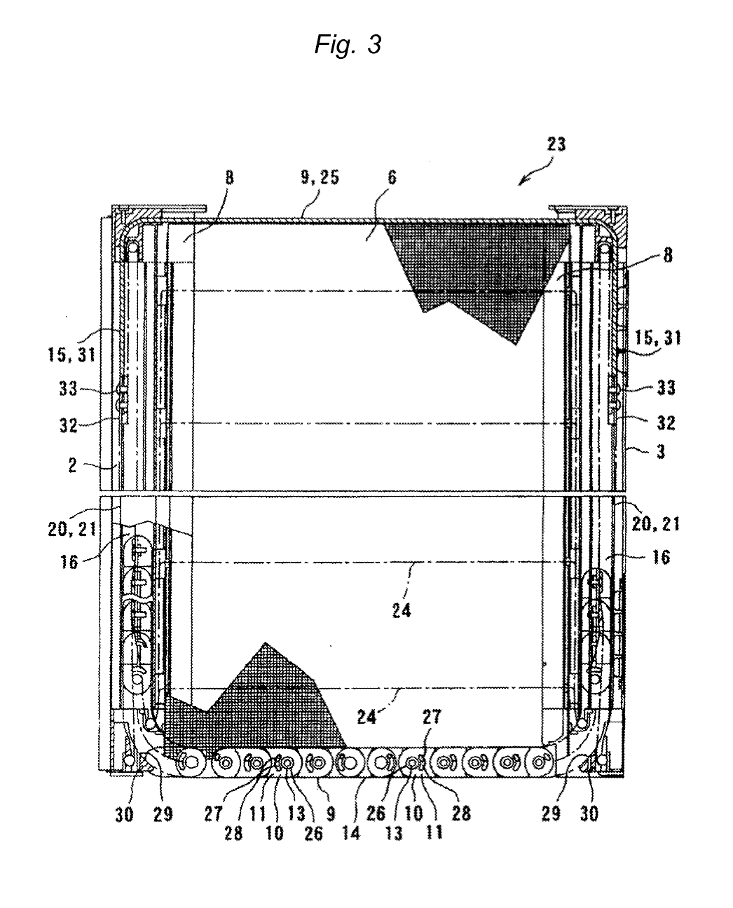

FIG. 4 is a cross-sectional view of the principal portion of the peripheries of the screen mounting frames of the screen device shown in FIG. 3.

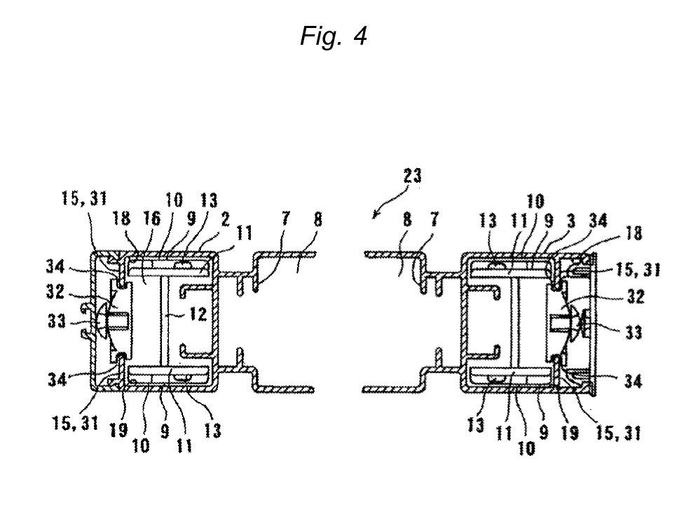

FIG. 5 is an exploded perspective view showing a principal portion near a free end of an upper slide guide frame formed of a band-shaped spring member.

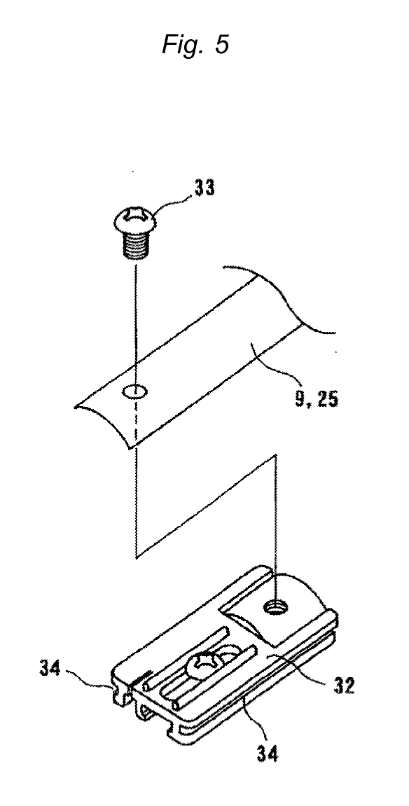

### REFERENCE NUMERALS

1, 23 screen device

2, 3 screen mounting frame

6 screen

9 slide guide frame

10 rigid unit

11 side wall portion

12 bridging portion

15 first housing section

16 second housing section

18, 19 inner wall surface portion

20 loop

21 tension member

25 band-shaped spring member

31 guide strip

32 connect piece

34 engaging groove

1-4. (canceled)

5. A screen device comprising: a screen which allows free contraction and expansion and is mounted between a pair of slidable screen mounting frames arranged on the left and right sides so as to oppose to each other, slide guide frames disposed respectively near both upper and lower end portions of the screen, the slide guide frames having flexibility, having free ends at both ends thereof, and being capable of being contained in and drawn out from the screen mounting frames and, on the other hand, the slide guide frames keeping their straightness at drawn out portions thereof when being drawn out from the screen mounting frames in association with the sliding movements of the screen mounting frames, characterized in that a first housing section and a second housing section configured to contain the two slide guide frames individually are partitioned and disposed respectively in the interior of the each screen mounting frame, the first housing section and the second housing section are arranged at different positions in the width direction in the interior of the screen mounting frame and extend in the direction of the height of the screen mounting frames, the two slide guide frames are connected to each other at the respective free ends contained in the same screen mounting frames by tension members each forming a loop having no crossing point.

6. The screen device according to claim 5, characterized in that the two slide guide frames are formed by continuously connecting rigid units each having a pair of side wall portions arranged so as to oppose to each other and a bridging portion which connects the both side wall portions to each other so as to allow rotation between the adjacent two rigid units.

7. The screen device according to claim 5, characterized in that the slide guide frame disposed near a lower end portion of the screen is formed by continuously connecting the rigid units each having the pair of side wall portions arranged so as to oppose to each other and the bridging portion which connects the both side wall portions to each other so as to allow rotation between the adjacent two rigid units, and the slide guide frame disposed near an upper end portion of the screen is formed of a band-shaped spring member having elasticity as well as flexibility.

8. A screen device according to claim 7, characterized in that a connect piece formed with engaging grooves at both left and right side end portions thereof is disposed at the free end of the upper slide guide frame formed of the band-shaped spring member, guide strips projecting inward from opposed inner wall surface portions of the screen mounting frame extending in the direction of the height of the screen mounting frame are disposed as the first housing section, and the guide strips are inserted into the engaging grooves of the connect piece, and the upper slide guide frame is slidable in the vertical direction in the first housing section by the connect piece being guided by the guide strips.
